(19) United States
(12) Patent Application Publication
(10) Pub. No.: US 2010/0329242 A1
(43) Pub. Date: Dec. 30, 2010

(54) SERVER APPARATUS AND SPEECH CONNECTION METHOD

(76) Inventors: Atsushi Yamazaki, Hachioji-shi (JP); Seiji Tani, Fussa-shi (JP)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/816,962

(22) Filed: Jun. 16, 2010

(30) Foreign Application Priority Data
Jun. 30, 2009 (JP) 2009-156003

(51) Int. Cl. H04L 12/66

(52) U.S. Cl. 370/352

(57) ABSTRACT

According to one embodiment, a server apparatus includes a memory, a determination module and a controller. The memory stores a management table associating terminal IDs specifying the terminals with media processing abilities owned by the terminals. The determination module refers the management table and determines whether information showing a media processing ability corresponding to the first terminal and information showing a media processing ability corresponding to the second terminal coincide with each other based on the reference result. The controller executes first processing for making speech connection between the first terminal and the second terminal by a peer-to-peer when the media processing abilities coincide with each other, and executes second processing for leading in a speech path between the first terminal and the second terminal to convert into the same media processing ability when the media processing abilities non-coincide with each other.

### CROSS-REFERENCE TO RELATED APPLICATIONS

This application is based upon and claims the benefit of priority from Japanese Patent Application No. 2009-156003, filed Jun. 30, 2009; the entire contents of which are incorporated herein by reference.

### FIELD

Embodiments described herein relate generally to such a system that makes voice communication among terminals. The embodiment relates to a server apparatus and a speech connection method which enables speech connection among terminals connected to an Internet Protocol (IP) network.

### BACKGROUND

In recent years, an IP telephone system which interactively transmits images and sounds as packet data in real time via the IP network has become widely used. The IP telephone system connects communication servers and a plurality of IP terminals to the IP network and enables communication among the IP terminals and communication among the IP terminals and the IP terminals and a trunk for each communication server.

When making the voice communication among the IP terminals, the IP telephone system performs the voice communication on a peer-to-peer basis which omits conversion processing by the communalization server. Here, it is needed for the peer-to-peer connection among IP terminals to exchange voice packets by using a common voice media codec (e.g., G.711, G.722, and G.729) among each IP terminal.

Meanwhile, in session initiation protocol (SIP) that is a representative protocol in the IP telephone system, when performing the peer-to-peer connection between two IP terminals, the speech connection results in failure if the IP terminals mutually performs negotiations on ability and if the abilities owned by an call origination side and a call termination side, namely the voice media codecs do not coincide with each other.

Regarding a conventional technique of this kind, a method, in which a call origination terminal includes ability information of its own terminal in an SIP message to transmit the information to a call termination terminal, decides a communication form based on the ability information included in an SIP response message from the call termination terminal and of the ability information of its own terminal, and sets a data conversion apparatus for performing data conversion, is disclosed (e.g., Jpn. Pat. Appln. KOKAI Publication No. 2003-309664).

In the mean time, the method given above enters tripartite negotiations with the call origination terminal, the call termination terminal and the data conversion apparatus when performing the speech connection to decide the communication form between the terminals, and does not take measures handling in a case where the abilities owned by the call origination side and the call termination side do not coincide with each other when performing the peer-to-peer connection between the two IP terminals.

### BRIEF DESCRIPTION OF THE DRAWINGS

A general architecture that implements the various feature of the embodiments will now be described with reference to the drawings. The drawings and the associated descriptions are provided to illustrate the embodiments and not to limit the scope of the invention.

FIG. 1 is an exemplary and schematic configuration view depicting a first embodiment of an IP telephone system;

FIG. 2 is an exemplary view depicting an example of storage content in a location table depicted in FIG. 1;

FIG. 3 is an exemplary view depicting an example of storage content in a codec ability table depicted in FIG. 1;

FIG. 4 is an exemplary flowchart depicting an acquisition procedure of codec information of an SIP terminal in an IP exchange apparatus in the first embodiment;

FIG. 5 is an exemplary flowchart depicting a speech connection processing procedure in the IP exchange apparatus in the first embodiment;

FIG. 6 is an exemplary sequence view depicting transmission and reception operations of information among SIP terminals and the IP exchange apparatus to be connected on a peer-to-peer basis in the first embodiment;

FIG. 7 is an exemplary sequence view depicting transmission and reception operations of information among SIP terminals and the IP exchange apparatus to be connected on a lead-in connection basis to a time switch;

FIG. 8 is an exemplary sequence view depicting a speech connection procedure among SIP terminals and an external terminal on a public network in the first embodiment;

FIG. 9 is an exemplary and schematic configuration view depicting a second embodiment of the IP telephone system;

FIG. 10 is exemplary view depicting an example of storage content in a dual tone multi frequency (DTMF) ability table depicted in FIG. 9;

FIG. 11 is an exemplary sequence view depicting an example for determining that the speech connection is based on a peer-to-peer connection in the second embodiment;

FIG. 12 is an exemplary sequence view depicting an example for determining that the speech connection is based on a lead-in connection in the second embodiment;

FIG. 13 is an exemplary view depicting a DTMF system decision rule in the second embodiment;

FIG. 14 is an exemplary view depicting a speech path form decision rule in the second embodiment;

FIG. 15 is an exemplary and schematic configuration view depicting a third embodiment of the IP telephone system;

FIG. 16A is an exemplary view depicting an example of first data of codec information allowed to be switched in the third embodiment; and

FIG. 16B is an exemplary view depicting an example of second data of the codec information allowed to be switched in the third embodiment.

### DETAILED DESCRIPTION

Various embodiments will be described hereinafter with reference to the accompanying drawings.

In general, according to one embodiment, a server apparatus which houses a plurality of terminals via an Internet Protocol network, comprising: a memory configured to store a management table associating terminal IDs specifying the terminals with media processing abilities owned by the terminals; a determination module configured to refer the management table when making speech connection between a first terminal and a second terminal among the plurality of terminals, and determine whether information showing a media processing ability corresponding to the first terminal and information showing a media processing ability corresponding to the second terminal coincide with each other based on the reference result; and a controller configured to execute first processing for making speech connection between the first terminal and the second terminal by a peer-to-peer when the media processing abilities coincide with each other, and execute second processing for leading in a speech path between the first terminal and the second terminal to convert into the same media processing ability when the media processing abilities non-coincide with each other.

### FIRST EMBODIMENT

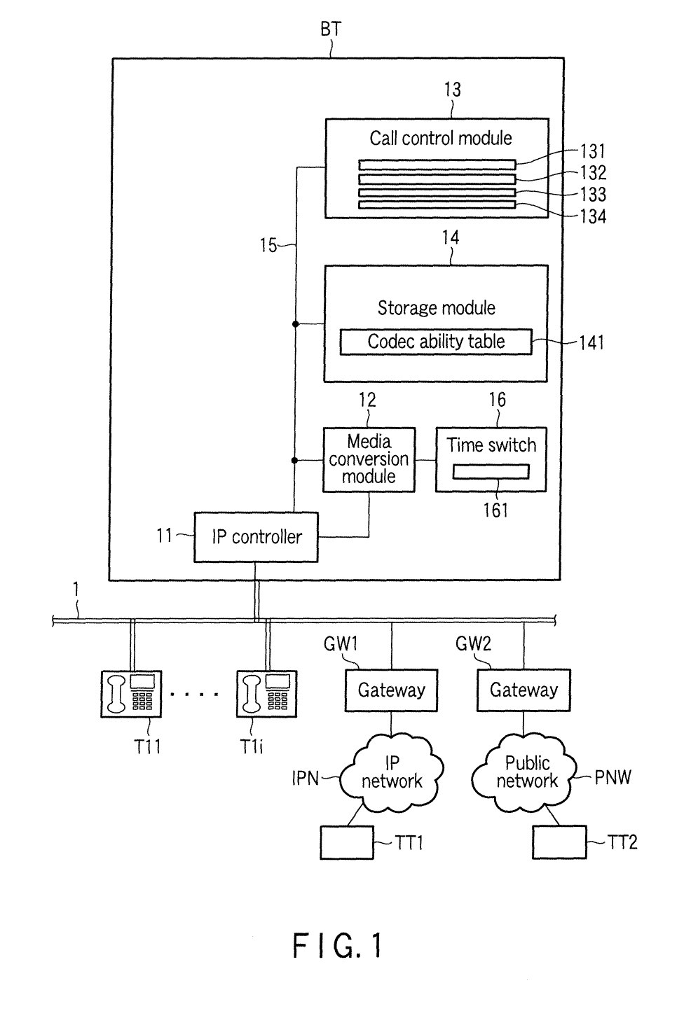

FIG. 1 is a schematic configuration view illustrating a first embodiment of an IP telephone system.

This telephone system includes a local area network (LAN) 1 for packet communication as an IP network. SIP telephone terminals T11-T1i (i is natural figure) are connected to the LAN 1. Each SIP telephone terminal T11-T1i has a speech processing function and such a media information processing function for video.

Gateways GW1, GW2 are connected to the LAN 1. Gateway GW1 connects between the LAN 1 and an IP public network IPN such as the Internet, and has a conversion function of a communication protocol and a signal format between the LAN 1 and the public network PNW.

The SIP telephone terminals T11-T1i and the gateways GW1, GW2 are connected to an IP exchange apparatus BT as a server apparatus.

The IP exchange apparatus BT includes an IP control module 11, a media conversion module 12, a call control module 13, and a storage module 14. These IP control module 11, the media conversion module 12, the call control module 13 and the storage module 14 are mutually connected through a data highway 15.

The LAN 1 is connected to the IP control module 11 if necessary. The IP control module 11 performs interface processing to and from the connected LAN 1. The IP control module 11 transmits and receives various kinds of control information regarding the aforementioned interface processing to and from the call control module 13 through the data highway 15.

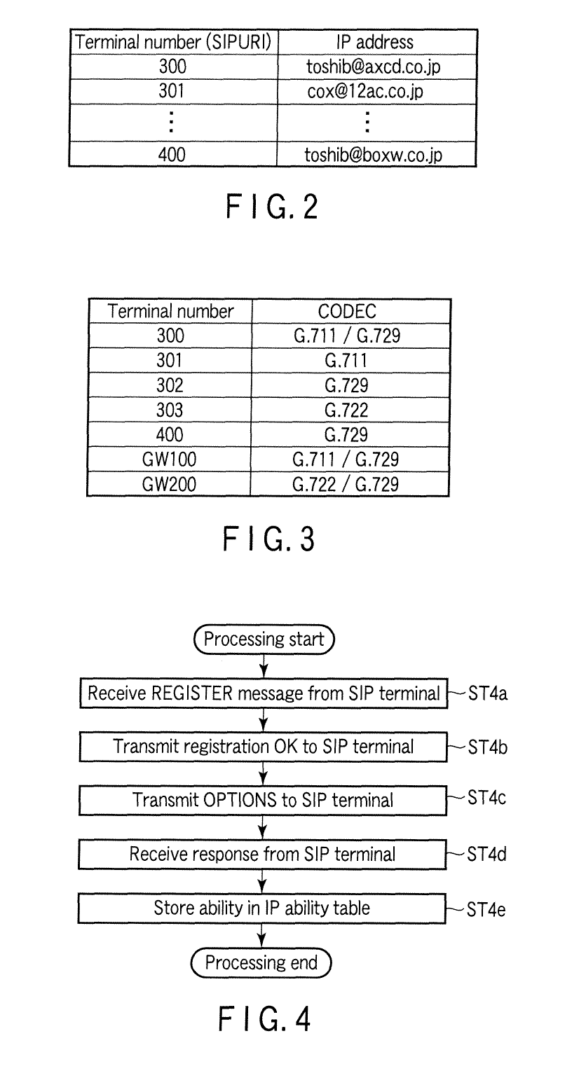

A time switch 16 is connected to the media conversion module 12. The media conversion module 12 performs processing of the control packet and the voice packet received by the IP control module 11, converts the packet into a PCM signal to output the PCM signal to the time switch 16, and converts the PCM signal from the time switch 16 into the packet to output the packet to the IP control module 11. The time switch 16 forms speech paths among the respective SIP telephone terminals T11-T1i registered in a location table 161 shown in FIG. 2.

The call control module 13 is composed of a CPU, a ROM, a RAM, etc, and controls each module of the IP exchange apparatus BT by software processing.

The storage module 14 stores routing information, etc., required to connection control by the call control module 13.

The storage module 14 is provided with a codec ability table 141. A table, showing a correspondence relationship among terminal numbers as terminal IDs assigned in advance to the SIP telephone terminals T11-T1i and the gateways GW1, GW2, is stored as shown in FIG. 3.

Meanwhile, the call control module 13 includes an ability inquiry module 131, a registration control module 132, an ability determination module 133, and a connection control module 134. After the registration of SIP URIs of SIP URIs of the SIP telephone terminals T11-T1i into the location table 161, the ability inquiry module 131 inserts the media processing ability, namely inquiry information of the codec into an OPTION message of the SIP of each SIP telephone terminal T11-T1i to transmit the OPTION message to the SIP telephone terminal T11-T1i. Regarding the gateways GW1, GW2, it is assumed that codec information is registered in the codec ability table 141 in advance.

The registration control module 132 acquires the codec information included in an SIP in an ACK message returned in response to an inquiry, and registers the codec information in the codec ability table 141 by associating the codec information with the terminal numbers of the terminals of returning sources.

The ability determination module 133 determines whether or not the codec information in an INVITE message transmitted from a call origination terminal with the codec information at a call termination terminal registered in the codec ability table 141 when establishing the speech connection. The ability determination module 133 may refer to the codec information registered in the codec ability table 141 from the terminal numbers of the call origination terminals.

The connection control module 134 makes the speech connection on a peer-to-peer basis between the call origination terminal and the call termination terminal if the codec information coincides with each other, and makes the speech connection on the lead-in basis by the time switch 16 between the call origination terminal and the call termination terminal if the codec information does not coincides with each other based on the determination result from the ability determination module 133.

Operations in the aforementioned configuration will be described hereinafter.

FIG. 4 shows a flowchart illustrating an acquisition procedure of the codec information through the SIP telephone terminals T11-T1i by means of the IP exchange apparatus BT. Here, if telephone terminals are the SIP telephone terminals T11-T1i, each SIP telephone terminal T11-T1i transmits REGISTER messages at a predetermined period to the IP exchange apparatus BT, and the IP exchange apparatus BT which has received the REGISTER messages registers the SIPURIs in the location table 161. If the SIP terminal T14 does not transmit the REGISTER messages at the predetermined period, the IP exchange apparatus BT recognizes that the SIP telephone terminal T14 does not exist, thus, the SIP telephone terminal T14 is disabled to make a telephone call.

It is assumed that the IP exchange apparatus BT receives the REGISTER message from the SIP telephone terminal T11 (Block ST4a). The IP exchange apparatus BT then performs REGISTER processing for the location table 161, and if the REGISTER message is “OK” (practical), returns an ACK message to the SIP telephone terminal T11 (Block ST4b).

Further, the IP exchange apparatus BT transmits an OPTION message to the SIP telephone terminal T11 of which the REGISTER processing has been done in order to inquire the ability of the SIP telephone terminal T11 (Block ST4c). The IP exchange apparatus BT then receives a response to the OPTION message (Block ST4d), extracts the codec information of the SIP included in the OPTION message to register the codec information in the codec ability table 141 (Block ST4e).

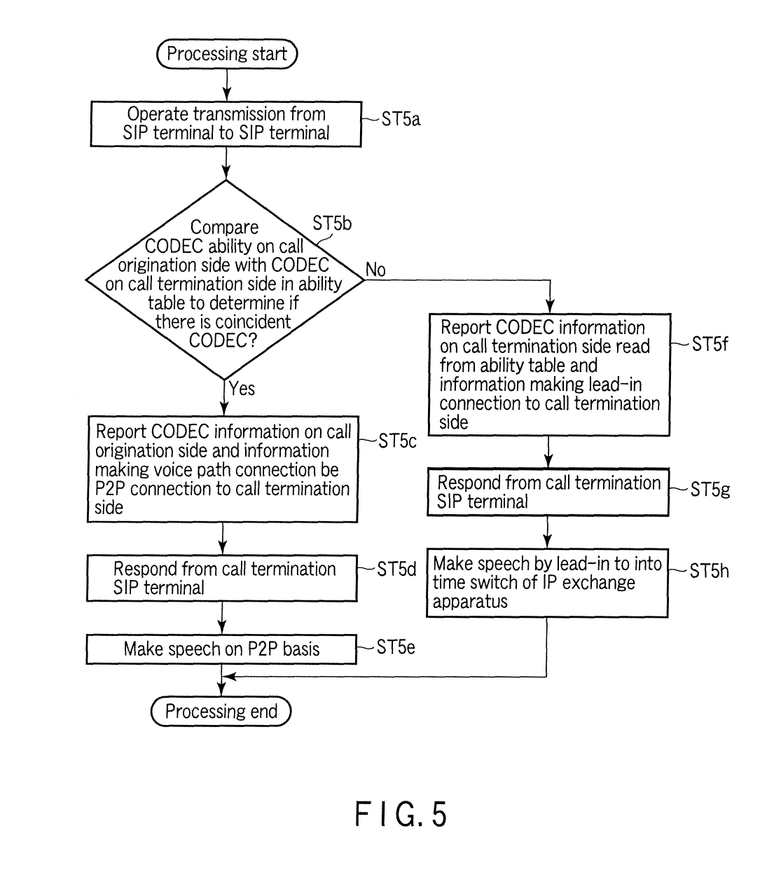

FIG. 5 shows a flowchart illustrating a speech connection processing procedure in the IP exchange apparatus BT.

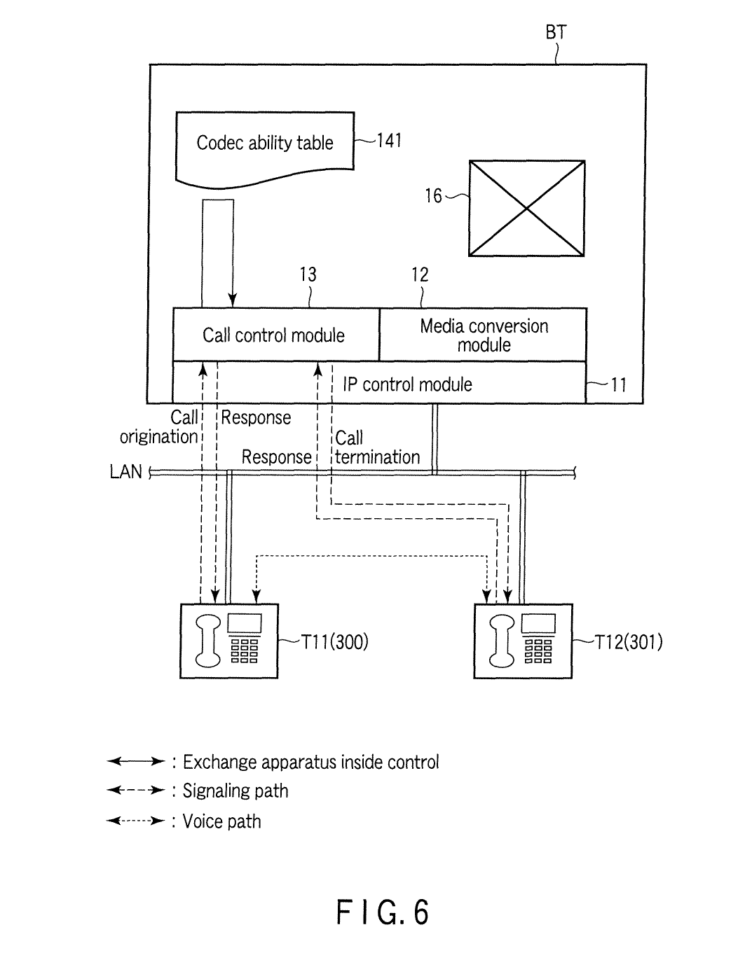

As shown in FIG. 6, it is assumed that the user of the SIP telephone terminal T11 performs a transmission operation to the SIP telephone terminal T12. The SIP telephone terminal T11 then transmits its call origination message (INVITE message) to the IP exchange apparatus BT.

When receiving the INVITE message, the IP exchange apparatus BT shifts the state from Block ST5a to Block ST5b, reads the codec information in the INVITE message and the codec information of the call termination terminal from the codec ability table 141, and compares to determine whether or not there are items of the codec information which coincide with each other. Here, since there is a codec which coincides with G.711, the IP exchange apparatus BT reports the codec information which has been received from the call origination side and the information for establishing peer-to-peer connection to the call termination side by superimposing both items of the information on the call terminal message (INVITE message to call termination side) (Block ST5c).

If the SIP telephone terminal T12 on the call termination side responds, and the response message is returned to the IP exchange apparatus BT, the IP exchange apparatus BT shifts the state from Block ST5d to Block ST5e, and there, forms a path state between tow person's speech on a peer-to-peer basis using G.711.

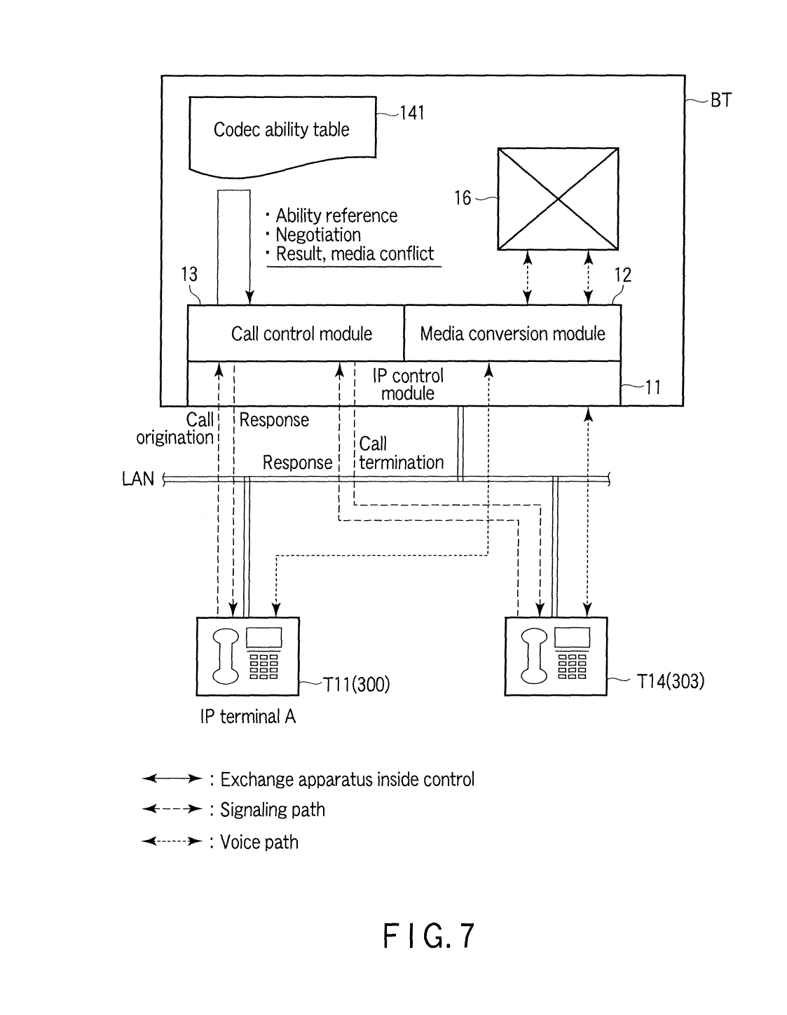

Meanwhile, as shown in FIG. 7, it is assumed that the user of the SIP telephone terminal T11 performs a call origination operation to the SIP telephone terminal T14. The SIP telephone terminal T11 then transmits a call origination message (INVITE message) to the IP exchange apparatus BT.

When receiving the call origination message (INVITE message), the IP exchange apparatus BT reads the codec information in the INVITE message and the codec information of the call termination terminal from the codec ability table 141, and compares to determine if there is both items of the information coincide with each other. Here, since the codec G.711 or G.729 on the call origination side and the codec G.722 on the call termination side do not coincide with each other, the IP exchange apparatus BT reports the codec information read from the codec ability table 141 and the information for lead-in connection with the time switch 16 to the call termination terminal T14 by superimposing both items of the information on the call termination message (Block ST5f).

When the SIP telephone terminal T12 on the call termination side responds, and when its response message is returned to the IP exchange apparatus BT, the IP exchange apparatus BT shifts the state from Block ST5g to Block ST5h to form the path state between two person's speeches on a lead-in basis to the time switch 16.

[Speech Operation Between SIP Telephone Terminal and Public Network]

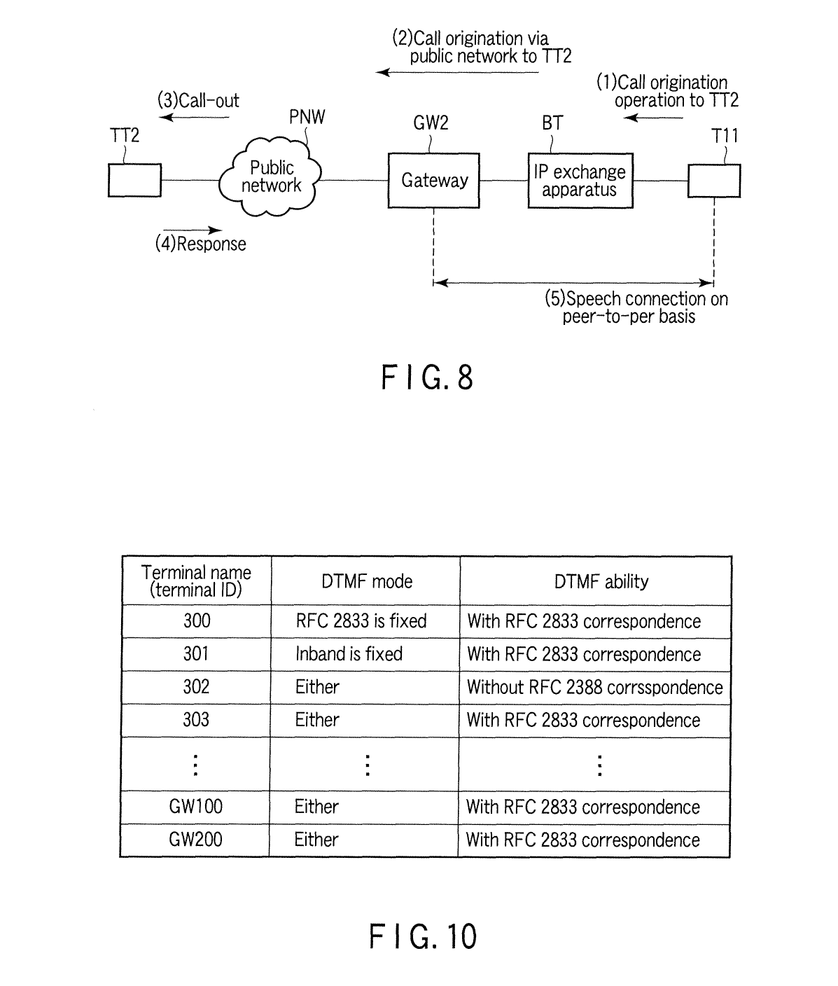

It is assumed, as shown in FIG. 8, that in an SIP telephone terminal T11, the user performs a call origination operation from the SIP telephone terminal T11 to another external telephone terminal TT2 ((1) in FIG. 8). The SIP telephone terminal T11 transmits a call origination message to the IP exchange apparatus BT. When receiving the call origination message, the IP exchange apparatus BT generates a call origination message addressed to the public network PNW, and transmits the call origination message to the public network PNW through the LAN 1 and the gateway GW2 ((2) in FIG. 8).

The public network PNW calls out the external telephone terminal TT2 on a call termination side ((3) in FIG. 8), when the external telephone terminal TT2 makes a response ((4) in FIG. 8), the IP exchange apparatus BT makes speech connection between the gateway GW2 and the SIP telephone terminal T11 on a peer-to-peer basis using G.729 ((5) in FIG. 8). Thus, the user of the SIP telephone terminal T11 can make a voice speech to and from the user of the external telephone terminal TT2. Also when the speech connection between the SIP telephone terminal T11 and an external telephone terminal TT2 on an IP public network IPN is established, the same procedure as that of the speech connection between the SIP telephone terminal T11 and the external telephone terminal TT2 is performed.

As mentioned above, in the first embodiment, before establishing the speech connection, the IP exchange apparatus BT stores the codec ability table 141 in which each of the terminal numbers of the SIP telephone terminals T11-T1i, and the gateways GW1, GW2 are associated with the codec owned by each of them, respectively, in the storage module 14, refers to the codec ability table 141 when the speech connection is established. The IP exchange apparatus BT then establishes the speech connection between the call origination terminal and the call termination terminal on a peer-to-peer basis using the coincident codec if the codec coincides with each other, and establishes speech connection on a lead-in basis between the call origination terminal and the call termination terminal by leading the path state there between into the time switch 16 if the codec do not coincide with each other.

Thus, even if the codec of the SIP terminals performing the speech connection do not coincide with each other, the IP exchange apparatus BT may establish the speech connection.

In the first embodiment given above, by using the existing message for registration, the IP exchange apparatus BT registers the codec information returned after inquiring the codec information to each SIP terminal T11-T1i in the codec ability table 141. Therefore, it is not needed to newly generate a signal dedicated to inquiry of the codec information, then; the IP telephone system of the first embodiment has an advantage in that the telephone system can be easily implemented.

### SECOND EMBODIMENT

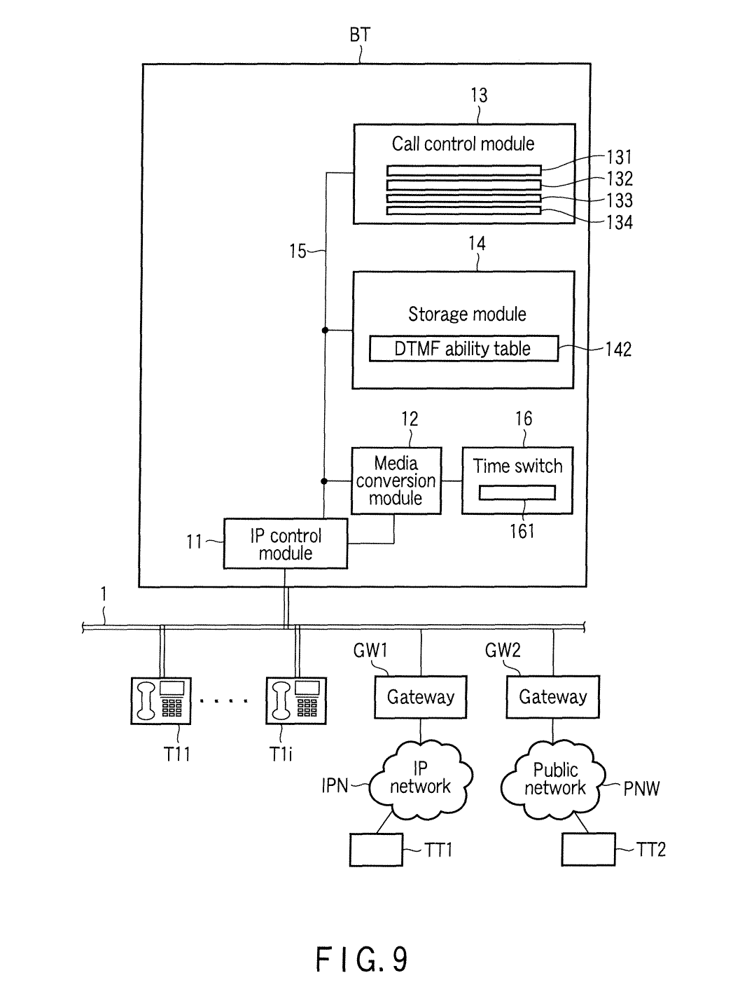

FIG. 9 shows a schematic configuration view illustrating a second embodiment of the IP telephone system. In FIG. 9, the same components as those of FIG. 1 are designated by identical symbols and their detailed descriptions will be omitted. In the second embodiment, a DTMF ability table 142 is installed in the storage module 14. A table, showing a correspondence relationship among the terminal numbers as terminal IDs assigned in advance to the SIP telephone terminals T11-T1i and the Gateways GW1, GW2, a DTMF mode and DTMF ability, is stored in the DTMF ability table 142 as shown in FIG. 10.

After registration of the SIPURIs of the SIP telephone terminals T11-T1i in the location table 161, an ability inquiry module 131 transmits inquiry information of the DTMF mode and the DTMF ability to the SIP terminals T11-T1i by inserting the inquiry information into the OPTION message of the SIP to each SIP telephone terminal T11-T1i. In terms of gateways GW1, GW2, it is assumed that the DTMF mode and the DTMF ability are registered in advance in the DTMF ability table 142.

A registration control module 132 acquires the DTMF mode and the DTMF ability included in an SIP in an ACK (response) message returned in response to an inquiry, and associates the DTMF mode and the DTMF ability with terminal numbers of terminals of returning sources to register them in the DTMF ability table 142.

An ability determination module 133 determines whether or not the DTMF mode and the DTMF ability in the INVITE message transmitted from a call origination terminal and the DIME mode and the DTMF ability of a call termination terminal registered in the DTMF ability table 142 coincide with one another when establishing the speech connection. Referring to the DIME mode and the DTMF ability registered in the DTMF ability table 142 from the terminal number of the call origination terminal is a possible approach.

If the aforementioned DTMF abilities coincide with each other, a connection control module 134 establishes speech connection on a peer-to-peer basis between the call origination terminal and the call termination terminal based on the determination result from the ability determination module 133. If the DTMF abilities do not coincide with each other, the control module 134 leads between the call origination terminal and the call termination terminal into the time switch 16 to establish the speech connection on a lead-in basis.

Operations in the configuration given above will be described.

Here, a method, which decides a transmission and reception ability of a DTMF signal of a terminal, a kind of a DIME signal to be actually used and a connection form of a voice path from a transmission and reception ability of a DTMF signal desired to be used, will be described.

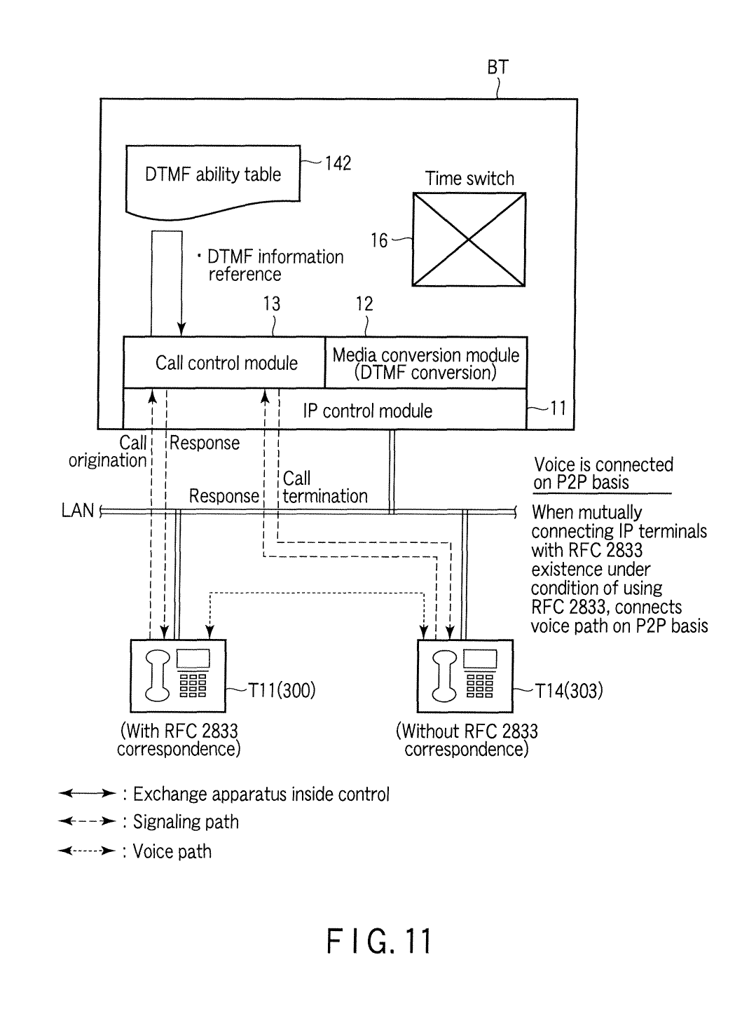

FIG. 11 shows a sequence view illustrating an example of determining that the speech connection is established on a peer-to-peer basis. It is assumed that the user of the SIP telephone terminal T11 performs a call origination operation to the SIP telephone terminal T14. The SIP telephone terminal T11 then transmits a call origination message to the IP exchange apparatus BT.

When receiving the call origination message from the SIP telephone terminal T11, the IP exchange apparatus BT can recognize if the ability of the SIP telephone terminal T11 corresponds to an RFC 2833 based on the call origination message. By referring to the DTMF ability table 142, the IP exchange apparatus BT recognizes if the ability of the SIP telephone terminal T14 corresponds to the RFC 2833. For connecting the SIP telephone terminal T11 to the SIP telephone terminal T14, three values are individually preset to select the RFC 2833, an Inband system, or either of them.

In this case, since the SIP telephone terminal Ill and the SIP telephone terminal T14 correspond to the RFC 2833 as the DTMF ability, and both the DTMF modes are set to select the RFC 2833 or to select either of them will be approval, media negotiations for SIP session establishment is performed so that both the SIP telephone terminals T11, T14 use the RFC 2833 as the DTMF system, and the voice path becomes the peer-to-peer connection between the SIP telephone terminal T11 and the SIP telephone terminal T14.

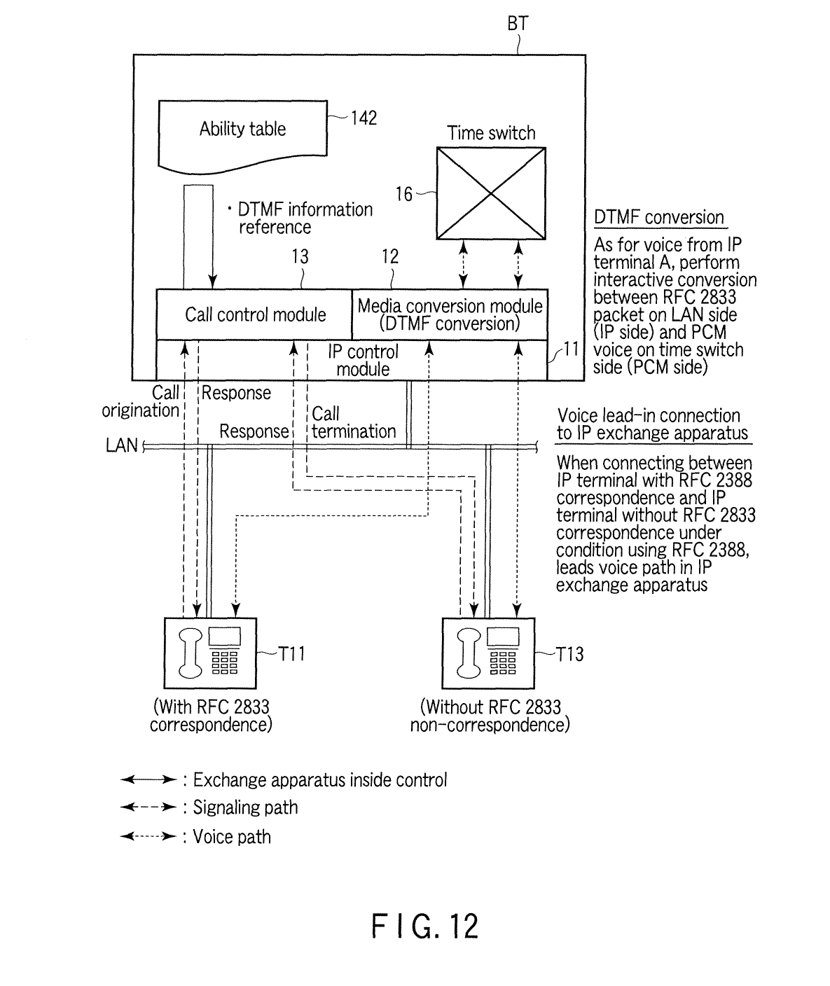

FIG. 12 shows a sequence view illustrating an example that the speech connection is a voice lead-in connection.

Now, it is assumed that the user of the SIP telephone terminal T11 performs a call origination operation to the SIP telephone terminal T13. The SIP telephone terminal T11 then transmits the call origination message to the IP exchange apparatus BT.

In the IP exchange apparatus BT, in a case where the SIP telephone terminal T11 corresponds to the RFC 2833 as the DTMF ability; however the SIP telephone terminal T13 does not correspond to the RFC 2833, and in a case where the DTMF mode is set so that the SIP telephone terminal T11 selects the RFC 2833, and the SIP telephone terminal T13 selects the Inband system, or either of them, the SIP telephone terminal T11 uses the RFC 2833 as the DTMF system, and the SIP telephone terminal T13 uses the Inband system as the DTMF system. The media negotiations for the SIP session establishment is performed so that the voice path is leaded in the time switch 16. By this lead-in connection, the DTMF signal in the RFC 2833 system of the SIP telephone terminal T11 is converted by means of the media conversion module 12 from an RFC 2833 packet into a PCM voice, or from the PCM voice into the RFC 2833 packet, thereby the transmission and reception of the DTMF signal are made possible between the SIP telephone terminal T11 and the SIP telephone terminal T13.

Setting methods of the DTMF mode and the DTMF ability for the DTMF ability table 142 includes various variations as follows.

As a setting method, information acquired by transmitting the OPTION messages that are methods for inquiring abilities of an SIP to the SIP telephone terminals T11-T1i may be set.

As another setting method, the DTMF mode and the DIME ability may be acquired from the OPTION messages which are periodically transmitted to the SIP telephone terminals T11-T1i for monitoring the existence of the SIP telephone terminals T11-T1i.

Periodical acquisition in this way enables always storing the latest information inside the SIP telephone terminals T11-T1i even if the user changes the setting of the SIP telephone terminals T11-T1i.

The information of presence or absence of correspondence to the RFC 2833 system as DTMF transmission abilities of the SIP telephone terminals T11-T1i may be contained in the REGISTER message that is a method to be used when registering the SIP telephone terminals T11-T1i in the location table 161 of the IP exchange apparatus BT.

Further, when receiving the REGISTER message that is a method to be used when registering the SIP telephone terminals T11-T1i in the location table 161 of the IP exchange apparatus BT, the DTMF mode and the DTMF ability may be acquired by transmitting the OPTION message to the SIP telephone terminals T11-T1i.

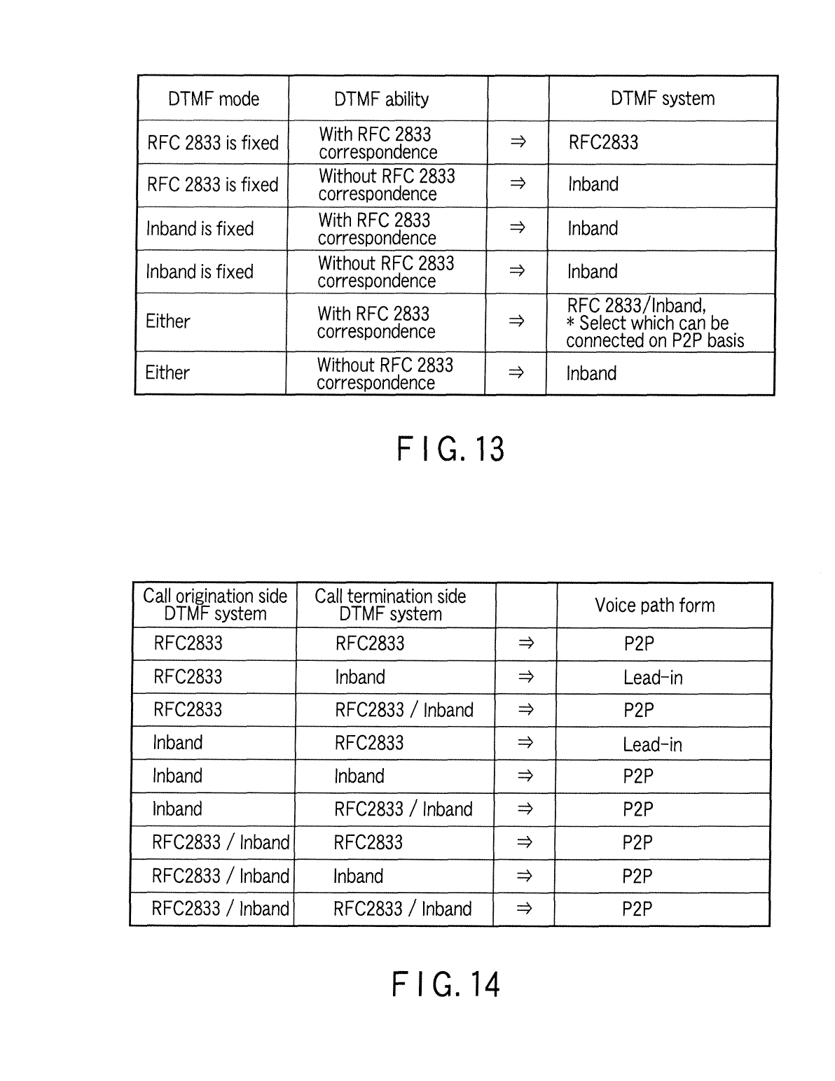

FIG. 13 shows a DTMF system decision rule.

This rule is a rule to be applied when the call control module 13 in the IP exchange apparatus BT performs media negotiations for establishing the SIP session, and the rule decides the DTMF systems of the individual SIP telephone terminals T11-T1i. Here, the DTMF system is decided by means of the combinations of the DTMF modes and the DTMF abilities set in the DTMF ability table 142.

FIG. 14 shows a voice path form decision rule.

The rule is a rule to be applied when the call control module 13 of the IP exchange apparatus BT performs media negotiations for establishing the SIP session, and the rule decides a voice path form between the call origination-side SIP terminal and the call termination-side SIP terminal.

As given above, even if in the second embodiment, similarly to the first embodiment, in the IP exchange apparatus BT, before establishing the speech connection, the storage module 14 has stored the DTMF ability table 142 in which each terminal number of each SIP telephone terminal T11-T1i and of each gateway GW1, GW2 and the DTMF mode and the DTMF ability owned by each of them are associated with one another. When making the speech connection, the IP exchange apparatus BT refers to the DTMF ability table 142, if the abilities coincide with each other, makes the speech connection on a peer-to-peer basis between the call origination terminal and the call termination terminal, and if the abilities do not coincide with each other, makes the speech connection by leading between the call origination terminal and the call termination terminal into the time switch 16.

Thus, even if the DTMF modes and the DTMF abilities of the SIP telephone terminals T11-T1i do not coincide with one another, the IP telephone system may establish the speech connection.

### THIRD EMBODIMENT

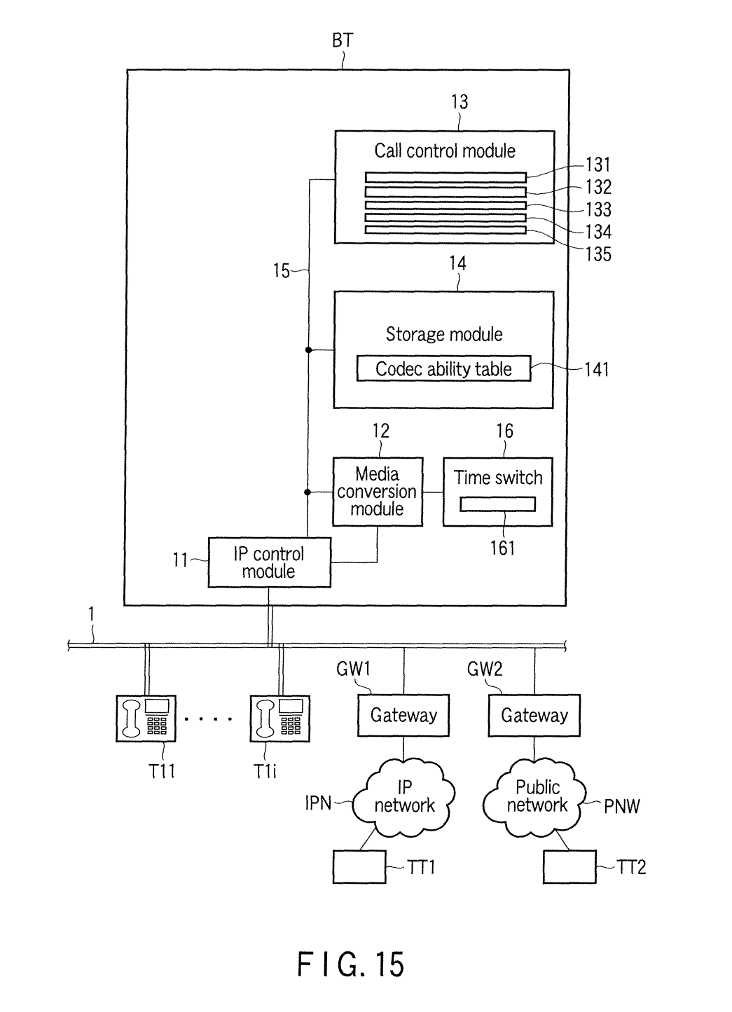

FIG. 15 shows a schematic configuration view illustrating a third embodiment of the IP telephone system. In FIG. 15, the same components as those of FIG. 1 are designated by identical symbols and their detailed descriptions will be omitted. In the third embodiment, if a plurality of items of codec information, such as an SIP telephone terminal T11 (terminal number 300) and gateways GW1, GW2, are registered in the codec ability table 141, a data setting change module 135 provided for the call control module 13 makes one item of the codec information effective.

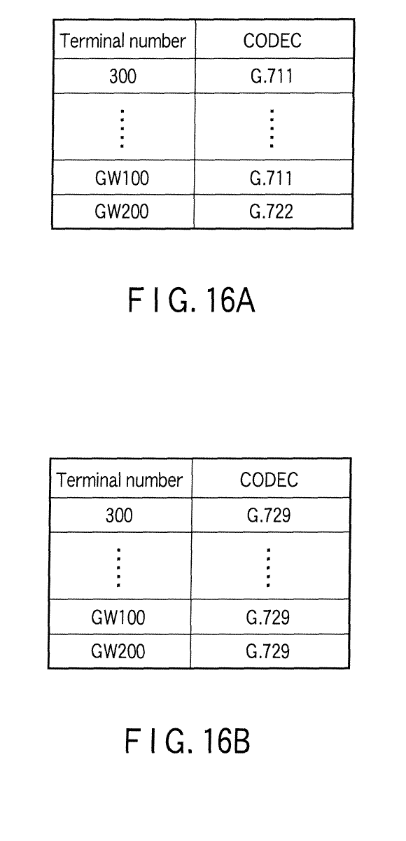

For instance, it is assumed that it is possible for the codec ability table 141 to be set in two pieces of data consisting of first data shown in FIG. 16A and second data shown in FIG. 16B.

In this state, when a time reaches 17:00, the data setting change module 135 switches the codec ability table 141 from the second data into the first data. In this way, it is possible to automatically change the codec information corresponding to each SIP telephone terminals T11-T1i and each gateway GW1, GW2 depending on a time. It is possible for switching conditions of the set data to use selection setting, etc., in accordance with priority order other than the time.

### OTHER EMBODIMENT

For instance, the data change method in the third embodiment may apply to the second embodiment.

While each embodiment given above has been described about the example in which the time switch 16 is installed in the IP exchange apparatus BT, the time switch 16 may be realized by a media converter eternally mounted on the IP exchange apparatus BT.

While each embodiment mentioned above has been described the example in which the SIP is applied, a protocol, named media gateway control (MEGACO), may be applied.

Other than this, the configuration of the IP telephone system, the function configuration of the IP exchange apparatus, kinds of media processing abilities, the control procedure and its content of each control may be embodied in various forms without departing from the spirit or scope.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The various modules of the systems described herein can be implemented as software applications, hardware and/or software modules, or components on one or more computers, such as servers. While the various modules are illustrated separately, they may share some or all of the same underlying logic or code. The accompanying claims and their equivalents are intended to cover such forms or modifications as would fall within the scope and spirit of the inventions.

What is claimed is:

1. A server apparatus which houses a plurality of terminals via an Internet Protocol network, comprising:
a memory configured to store a management table associating terminal IDs specifying the terminals with media processing abilities owned by the terminals;
a determination module configured to refer the management table when making speech connection between a first terminal and a second terminal among the plurality of terminals, and determine whether information showing a media processing ability corresponding to the first terminal and information showing a media processing ability corresponding to the second terminal coincide with each other based on the reference result; and
a controller configured to execute first processing for making speech connection between the first terminal and the second terminal by a peer-to-peer when the media processing abilities coincide with each other, and execute second processing for leading in a speech path between the first terminal and the second terminal to convert into the same media processing ability when the media processing abilities non-coincide with each other.

2. The apparatus of claim 1, wherein the memory stores data associating at least one of a kind of a codec for use in the speech connection by the peer-to-peer, and a communication ability of a dual tone multi frequency signal as the media processing ability with the terminal IDs.

3. The apparatus of claim 1, further comprising:
an inquiry module configured to inquire the media processing abilities to the plurality of terminals; and
a registration controller configured to register information showing the media processing abilities to be returned in response to the inquiry in the management table.

4. The apparatus of claim 3, wherein the inquiry module transmits an inquiry message about the media processing abilities to the terminals concerned after registering the terminal IDs of the terminals in a registering memory, when it is possible to make speech connection to terminal of which the terminal IDs are registered in the registering memory.

5. The apparatus of claim 4, wherein the inquiry module inserts inquiry information of the media processing ability into already known registration message and transmits the registration message to the terminal.

6. The apparatus of claim 3, wherein the inquiry module periodically transmits inquiry messages of the media processing abilities to each of the plurality of terminals to update the management table.

7. The apparatus of claim 1, further comprising:
a switching controller configured to set information showing one media processing ability in accordance with preset conditions when it is possible to register information showing a plurality of media processing abilities with a terminal ID in the management table.

8. The apparatus of claim 7, wherein the switching controller uses at least one of a time zone and a priority order to determine the conditions.

9. The apparatus of claim 1, further comprising:
a converter configured to convert the media processing abilities, wherein the controller makes the converter make speech connection between the first terminal and the second terminal, as the second processing.

10. A speech connection method for use in a server apparatus which houses a plurality of terminals via an Internet Protocol network, comprising:
storing a management table associating terminal IDs specifying the terminals with media processing abilities owned by the terminals;
referring to the management table when making speech connection between a first terminal and a second terminal among the plurality of terminals;
determining whether information showing a media processing ability corresponding to the first terminal coincides with information showing a media processing ability corresponding to the second terminal;
executing first processing configured to make speech connection between the first terminal and the second terminal by a peer-to-peer when the media processing abilities coincide with each other based on the determination result; and
executing second processing configured to lead in a speech path between the first terminal and the second terminal to convert into the same media processing ability when the media processing abilities non-coincide with each other.
